(19) United States
(12) Patent Application Publication
(10) Pub. No.: US 2015/0365365 A1
(43) Pub. Date: Dec. 17, 2015

(54) METHOD AND APPARATUS FOR MODIFYING MESSAGE

(71) Applicant: Electronics and Telecommunications Research Institute, Daejeon (KR)

(72) Inventors: Eun-Jin KO, Daejeon (KR); Jong-Hyun JANG, Daejeon (KR)

(21) Appl. No.: 14/726,700

(22) Filed: Jun. 1, 2015

(30) Foreign Application Priority Data
Jun. 16, 2014 (KR) 10-2014-0073116

(51) Int. Cl. H04L 12/58

(52) U.S. Cl. CPC H04L 51/063; H04L 51/36

(57) ABSTRACT

The present invention relates to a method and an apparatus for modifying a previously sent UC message. The method of modifying a previously sent message in accordance with the present invention may include: receiving, by input of a user, a modified phrase of a message to be modified that is selected among a list of previously sent messages; generating a comparison string by adding at least one letter preceding the modified phrase and one letter following the modified phrase to the modified phrase; comparing a length of the comparison string with a length of an entire string of the message to be modified; transmitting a modification message having the comparison string included therein if the length of the comparison string is smaller than the length of the entire string of the message to be modified; and transmitting the entire string of the message to be modified having the modified phrase included therein if the length of the comparison string is greater than or equal to the length of the entire string of the message to be modified.

### CROSS-REFERENCE TO RELATED APPLICATIONS

This application claims the benefit of Korean Patent Application No. 10-2014-0073116, filed with the Korean Intellectual Property Office on Jun. 16, 2014, the disclosure of which is incorporated herein by reference in its entirety.

### BACKGROUND

1. Technical Field

The present invention relates to modifying a message, more specifically to a method and an apparatus for modifying a unified communications message that is already sent.

2. Background Art

The volume of network data traffic using wire/wireless communication networks has rapidly increased recently, and particularly, the volume of data used on the wireless networks has sharply surged over the volume of data used on the wire networks. Under this circumstance, the communication means have evolved from mail to telephone, e-mail, multimedia message services (MMS), instant message services and to unified communications (UC) services. As the e-mail, MMS, instant message services and UC services are mainly used, it has become possible for anyone to attach and deliver characters and multimedia data from a computer, mobile phone, smartphone and the like.

However, the ease of transmitting these messages occasionally results in the need for modifying or canceling a transmitted message after the message has been drafted and transmitted. Conventionally, modifying an erroneously transmitted message has required: separating a message on the premise that all transmitted messages are to be modified; storing information, which designates how much and from which location of a phrase or attached file included in the separated message is to be modified, in a header of the data payload portion; and then storing the modified information.

However, with this conventional method, the previously transmitted message separator information and the data about how much and where is to be modified need to be always added and transmitted, inevitably increasing the amount of transmitted data.

### SUMMARY

Contrived to solve the problem of the conventional method of modifying a transmitted message, an embodiment of the present invention provides a method of modifying a transmitted message that does not need to send supplemental information, such as a message separator and a modification location within the message, when the transmitted message needs to be modified.

An embodiment of the present invention provides a method of modifying a transmitted message that, by generating a comparable string that is present within a message, finds and modifies a target message and a portion to be modified through a simple comparison string process in a message-receiving device.

An aspect of the present invention features a method of modifying a previously sent message in a communication device. The method of modifying a previously sent message may include: receiving, by input of a user, a modified phrase of a message to be modified that is selected among a list of previously sent messages; generating a comparison string by adding at least one letter preceding the modified phrase and one letter following the modified phrase to the modified phrase; comparing a length of the comparison string with a length of an entire string of the message to be modified; transmitting a modification message having the comparison string included therein if the length of the comparison string is smaller than the length of the entire string of the message to be modified; and transmitting the entire string of the message to be modified having the modified phrase included therein if the length of the comparison string is greater than or equal to the length of the entire string of the message to be modified.

In an embodiment, the generating of the comparison string may include: checking for a location of the modified phrase within the message to be modified; generating the comparison string by adding one letter following the modified phrase to the modified phrase if the modified phrase is located at a head of the message to be modified; generating the comparison string by adding one letter preceding the modified phrase to the modified phrase if the modified phrase is located at a tail of the message to be modified; and generating the comparison string by adding one letter preceding the modified phrase and one letter following the modified phrase to the modified phrase if the modified phrase is located at a middle of the message to be modified;

In an embodiment, the method may further include: receiving, by a receiving device, the modification message; reading, by the receiving device, a message previously received from a sender by using sender information included in a header of the modification message; extracting, by the receiving device, a comparison string from the modification message; and searching and modifying, by the receiving device, a phrase to be modified within the previously received message by using the extracted comparison string.

In an embodiment, the method may further include displaying, by the receiving device, a modification detail of the phrase to be modified.

Another aspect of the present invention features a communication device including a display; a memory; and a processor, wherein the memory includes program instructions for causing the processor to: display a list of messages previously sent to a user on the display; receive from the user a modified phrase of a message to be modified that is selected among the list of previously sent messages; generate a comparison string including the modified phrase, the comparison string being generated by adding at least one letter preceding the modified phrase and one letter following the modified phrase to the modified phrase; compare a length of the comparison string with a length of an entire string of the message to be modified; transmit a modification message having the comparison string included therein if the length of the comparison string is smaller than the length of the entire string of the message to be modified; and transmit the entire string of the message to be modified having the modified phrase included therein if the length of the comparison string is greater than or equal to the length of the entire string of the message to be modified.

With the embodiments of the invention, it becomes possible to accurately locate and modify a phrase of a message to be modified through a simple comparison string process in a message-receiving device by generating a comparable string that is present within the message, when modification needs to be made to a previously sent UC message, without sending supplemental information, such as a message separator and a modification location within the message.

### BRIEF DESCRIPTION OF DRAWINGS

FIG. 1 illustrates a message transfer structure to which a method of modifying a message in accordance with the present invention is applied.

FIG. 2 is a brief illustration of how a transmitted UC message data is modified in accordance with an embodiment of the present invention.

FIG. 3 illustrates a message header including message separation information.

FIG. 4 illustrates the structure of a comparison string that includes a modified phrase transmitted to a receiving device from a transmitting device in accordance with an embodiment of the present invention.

FIG. 5 is a flow diagram showing how a message is modified in accordance with an embodiment of the present invention.

FIG. 6 shows the details of how a comparison string is generated in accordance with an embodiment of the present invention.

FIG. 7A is a flow diagram showing how a message is processed in accordance with an embodiment of the present invention.

FIG. 7B is a flow diagram showing how a previously received message is modified using a modification message in accordance with an embodiment of the present invention.

FIG. 8 is a block diagram showing the structure of a communication device to which the method of modifying a message in accordance with the present invention may be applied.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted.

Unless otherwise stated, any expression in singular form in the description and the claims shall be interpreted to generally mean “one or more.”

Moreover, any terms “module,” “unit,” “interface,” etc. used in the description shall generally mean computer-related objects and can mean, for example, hardware, software and a combination thereof.

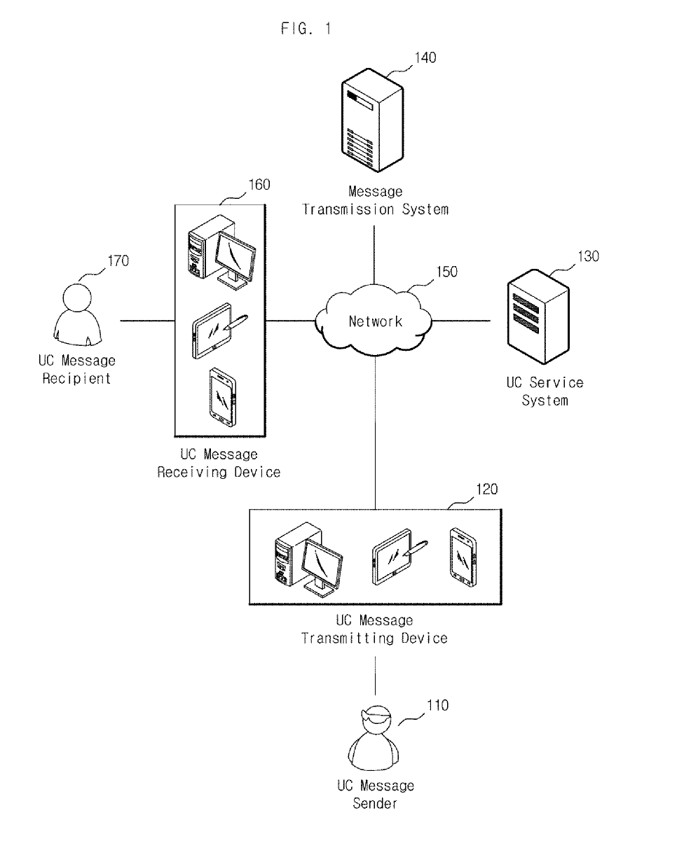

FIG. 1 illustrates a message transfer structure to which a method of modifying a message in accordance with the present invention is applied.

As illustrated, in order to communicate a UC message, a UC message sender 110 accesses a UC service system 130 by use of a UC message transmitting device 120. Once the access is made and the message is sent, the message is transferred to a message receiving device 160 through a message transmission network 150 and, if necessary, via a message transmission system 140 (e.g., an SMS transmission system or an instant message transmission system), and a UC message recipient 170 is notified that the message is received.

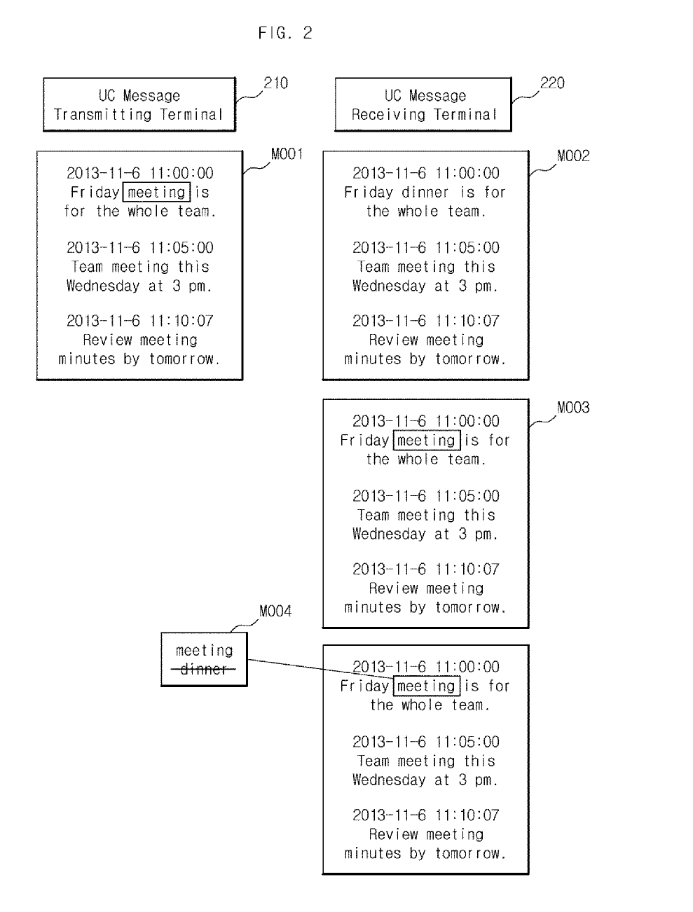

FIG. 2 is a brief illustration of how a transmitted UC message data is modified in accordance with an embodiment of the present invention.

A UC message transmitting device 210 has a transmitted UC messages list M001 displayed thereon. Here, a message receiving device 220 also has a received UC messages list M002. The UC messages that are already sent may have header data that is message separation information for separating the messages from one another. FIG. 3 illustrates the structure of a message header having the message separation information included therein. As illustrated, the message separation information is structured to include 11 digits of sender information and the transmission time of the sent message that includes year (4 digits)/month (2 digits)/day (2 digits)/hour (2 digits)/minute (2 digits)/second (2 digits)/serial number (2 digits).

When a user of the UC message transmitting device 210 discovers a phrase to be modified among the transmitted messages, the user selects and modifies the pertinent phrase and retransmits the modified phrase. FIG. 2 shows an example of modifying “dinner” to “meeting” in the transmitted messages. Here, a modification message that is constituted with comparison string data, which is generated by attaching at least one letter before and after the modified phrase to the modified phrase, will be sent from the transmitting device 210 to the receiving device 220.

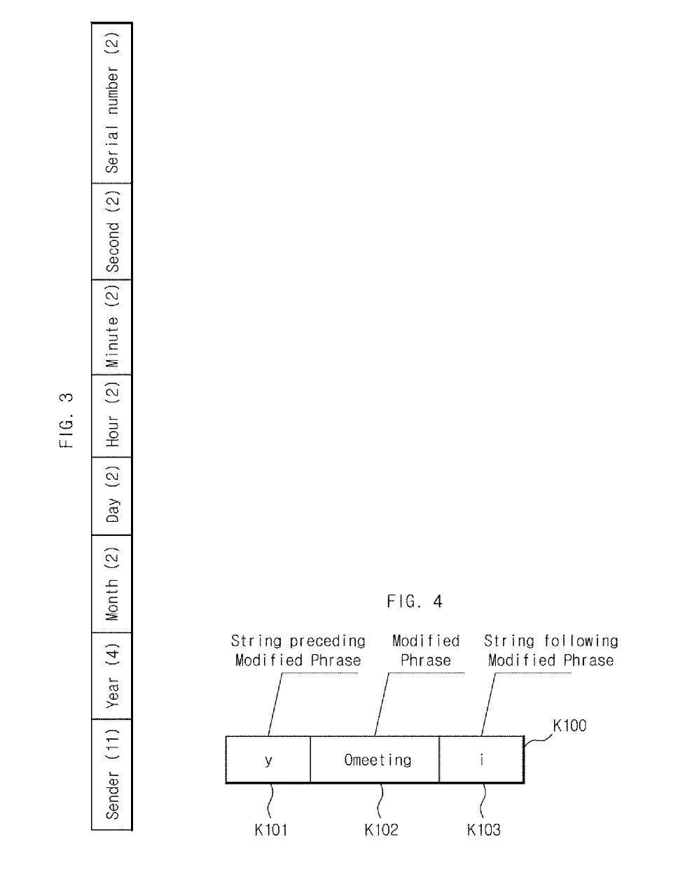

FIG. 4 illustrates the structure of a comparison string that includes a modified phrase transmitted to a receiving device from a transmitting device in accordance with an embodiment of the present invention. As illustrated, a comparison string K100 consists of a string K101 before the modified phrase, the modified phrase K102 and a string K103 after the modified phrase. For example, the comparison string data will be generated by having the letter “y” and the letter “i” added before and after, respectively, the modified phrase “meeting.”

Referring to FIG. 2 again, the receiving device 220 may modify the pertinent phrase by use of the comparison string date received from the transmitting device 210. The recipient may verify the modification to the modified phrase in a received message list M003. Moreover, in case the recipient wants to check modification history information, the recipient may press the pertinent phrase to display a modification history M004 on a screen.

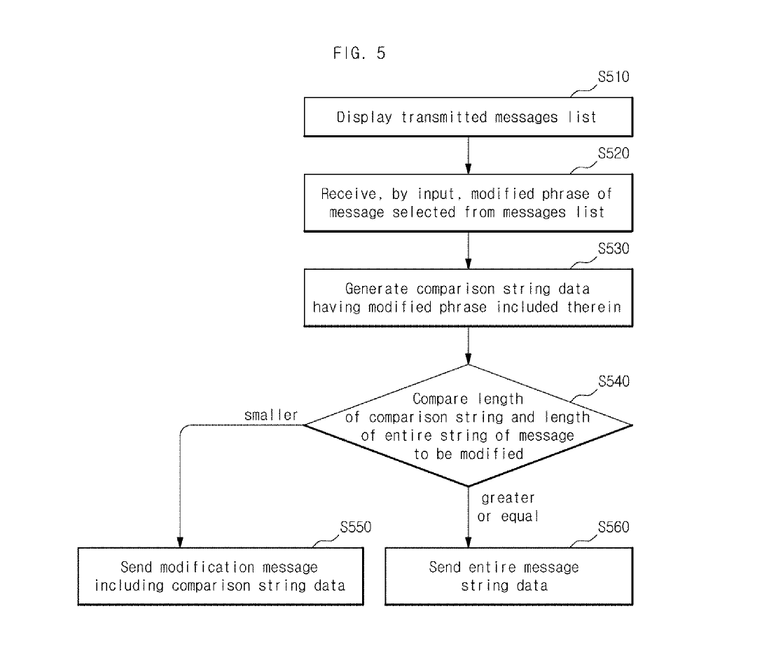

FIG. 5 is a flow diagram showing how a message is modified in accordance with an embodiment of the present invention.

In S510, a transmitted messages list is displayed.

In S520, a modified phrase of a message selected in the messages list is inputted by a user.

In S530, comparison string data having the modified phrase included therein is generated. In an embodiment, the comparison string data may be generated by having at least one letter before and after the modified phrase attached to the modified phrase.

In S540, the length of the comparison string and the length of the entire string of the message to be modified are compared with each other.

If the length of the comparison string is determined to be smaller than the length of the entire string of the message to be modified, a modification message including the comparison string data is transmitted to the receiving device (S550), but otherwise, the entire message including the modified phrase is re-transmitted (S560).

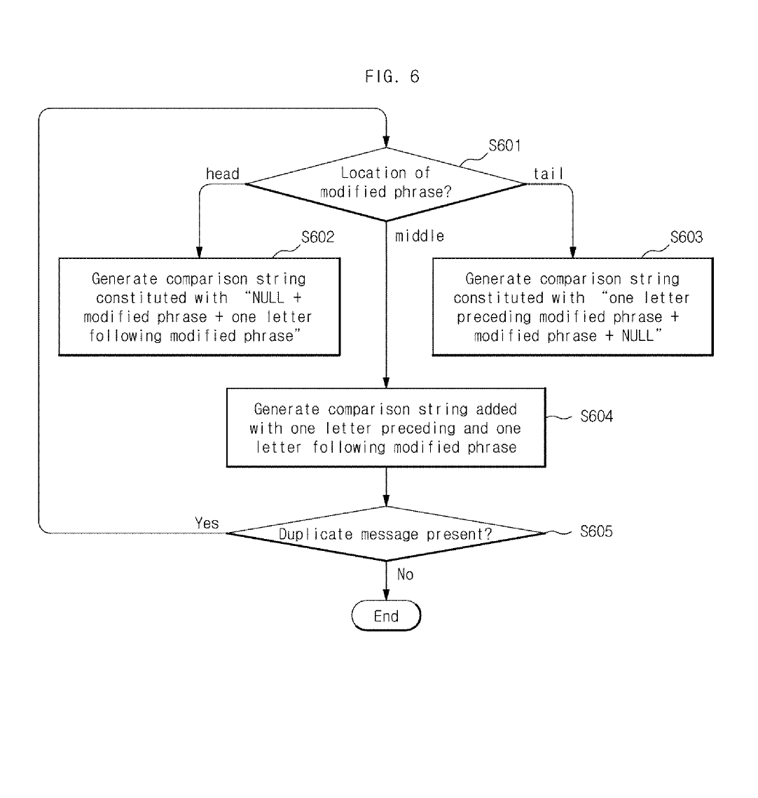

FIG. 6 shows the details of how the comparison string of FIG. 5 is generated (i.e., S530) in accordance with an embodiment of the present invention.

In S601, the location of the modified phrase is checked within the message to be modified. That is, it is checked whether the modified phrase is located at the head, middle or tail of the entire message.

If the modified phrase is located at the head of the message to be modified, a comparison string consisting of “NULL+modified phrase+one letter following the modified phrase” is generated (S602).

If the modified phrase is located at the tail of the message to be modified, a comparison string consisting of “one letter preceding the modified phrase+modified phrase+NULL” is generated (S603). For example, in the example shown in FIG. 2, if “Friday” is modified to “Wednesday,” the generated comparison string will be “NULL+Fri+d.”

If the modified phrase is located in the middle of the message to be modified, a comparison string is generated by having one letter preceding the modified phrase and one letter following the modified phrase added to the modified phrase (S604).

Next, it is checked whether there is a duplicate message including a comparison string K100 having the modified phrase therein among the transmitted message (S605). If there is a duplicate message, the S601 step is repeated, and the steps of generating a comparison string by adding a letter preceding the modified phrase and a letter following the modified phrase based on the location of the modified phrase (S602 to S606).

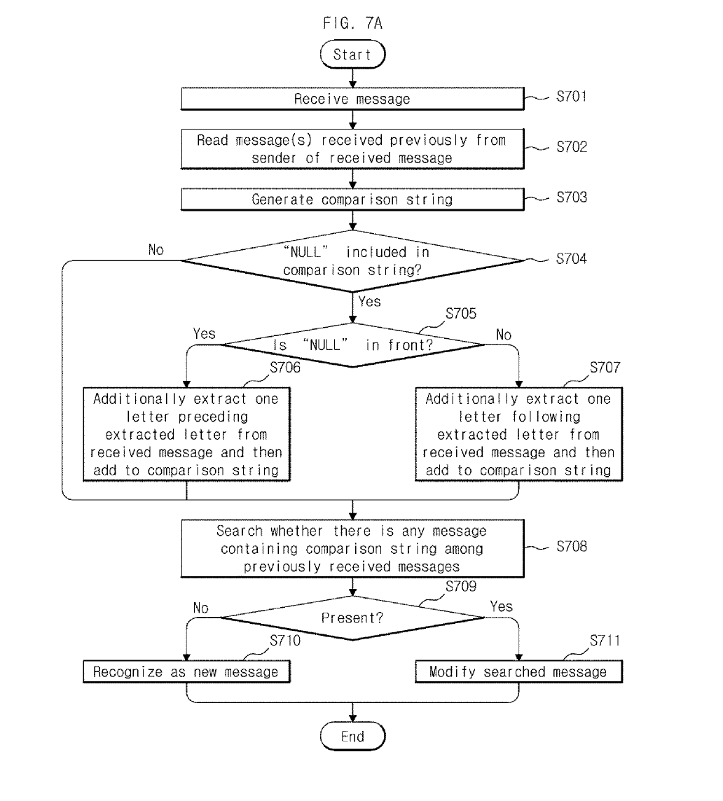

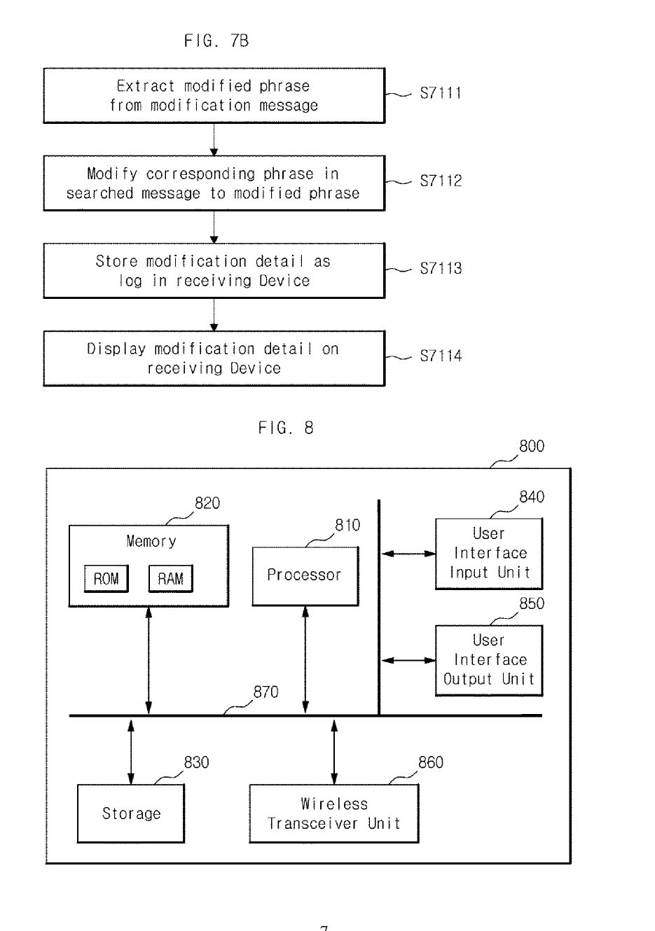

FIG. 7A is a flow diagram showing how a message is processed in accordance with an embodiment of the present invention.

Once a UC message receiving device receives a message (S701), a message sent by a sender is read from a list of messages received already from the sender (S702), by use of sender information included in a message header.

Since it is not possible for the receiving device to determine whether the received message is a modification message or a new message, a comparison string (K101+K103) is generated by extracting the first letter and the last letter of the received message (S703), and it is checked whether there is any message having the comparison string among the message that have been received already (S704 to S708).

Specifically, it is determined whether the comparison string (K101+K103) contains “NULL” (S704), and if “NULL” is contained therein, it is further determined whether “NULL” is located in front of or behind the comparison string (S705).

In the case where “NULL” is located in front of the comparison string, the modified phrase is located at the head of the message. In such a case, one letter preceding the extracted letter is additionally extracted from the received message and then is added to the comparison string (S706).

If, on the other hand, “NULL” is located behind the comparison string, the modified phrase is located at the tail of the message. In such a case, one letter following the extracted letter is additionally extracted from the received message and is added to the comparison string (S707).

Then, it is searched whether there is any message containing the comparison string among the messages that have been received already (S708), and if there is such a message, the searched message may be modified (S711) using the modification message received in the step of S701. The steps for modifying the received message by use of the modification message will be described later in detail with reference to FIG. 7B.

If, on the other hand, there is no message containing the comparison string, it is recognized that the message received in the step of S701 is not a modification message but a new message, and that the new message is received may be displayed on the device (S710).

FIG. 7B is a flow diagram showing how a previously received message is modified using a modification message in accordance with an embodiment of the present invention.

Firstly, the modified phrase is extracted from the modification message (S7111).

Using the extracted modified phrase, a corresponding phrase of the message that has been already received is modified (S7112).

After storing a modification detail as log data in the receiving device (S7113), the modification detail may be displayed on the receiving device.

FIG. 8 is a block diagram showing the structure of a communication device to which the method of modifying a message in accordance with the present invention may be applied. As illustrated, the communication device may include one or more of a processor 810, a memory 820, a storage 830, a user interface input unit 840, a user interface output unit 850, and a wireless transceiver unit 860, each of which communicates through a bus 870.

The apparatus and the method in accordance with an embodiment of the present invention may be implemented in the form of program instructions that are executable through various computer means and written in a computer-readable medium, which may include program instructions, data files, data structures, or the like, in a stand-alone form or in a combination thereof.

The program instructions stored in the computer readable medium can be designed and configured specifically for the present invention or can be publically known and available to those who are skilled in the field of software. Examples of the computer readable medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. A method of modifying a previously sent message in a communication device, the method comprising:
receiving, by input of a user, a modified phrase of a message to be modified that is selected among a list of previously sent messages;
generating a comparison string by adding at least one letter preceding the modified phrase and one letter following the modified phrase to the modified phrase;
comparing a length of the comparison string with a length of an entire string of the message to be modified;
transmitting a modification message having the comparison string included therein if the length of the comparison string is smaller than the length of the entire string of the message to be modified; and
transmitting the entire string of the message to be modified having the modified phrase included therein if the length of the comparison string is greater than or equal to the length of the entire string of the message to be modified.

2. The method of claim 1, wherein the generating of the comparison string comprises:
checking for a location of the modified phrase within the message to be modified;
generating the comparison string by adding one letter following the modified phrase to the modified phrase if the modified phrase is located at a head of the message to be modified;
generating the comparison string by adding one letter preceding the modified phrase to the modified phrase if the modified phrase is located at a tail of the message to be modified; and
generating the comparison string by adding one letter preceding the modified phrase and one letter following the modified phrase to the modified phrase if the modified phrase is located at a middle of the message to be modified;

3. The method of claim 1, further comprising:
receiving, by a receiving device, the modification message;
reading, by the receiving device, a message previously received from a sender by using sender information included in a header of the modification message;
extracting, by the receiving device, a comparison string from the modification message; and
searching and modifying, by the receiving device, a phrase to be modified within the previously received message by using the extracted comparison string.

4. The method of claim 3, further comprising displaying, by the receiving device, a modification detail of the phrase to be modified.

5. A communication device comprising:
a display;
a memory; and
a processor,
wherein the memory includes program instructions for causing the processor to:
display a list of messages previously sent to a user on the display;
receive from the user a modified phrase of a message to be modified that is selected among the list of previously sent messages;
generate a comparison string including the modified phrase, the comparison string being generated by adding at least one letter preceding the modified phrase and one letter following the modified phrase to the modified phrase;
compare a length of the comparison string with a length of an entire string of the message to be modified;
transmit a modification message having the comparison string included therein if the length of the comparison string is smaller than the length of the entire string of the message to be modified; and
transmit the entire string of the message to be modified having the modified phrase included therein if the length of the comparison string is greater than or equal to the length of the entire string of the message to be modified.

6. The communication device of claim 5, wherein the program instructions for causing the processor to generate the comparison string comprises instructions for causing the processor to:
check for a location of the modified phrase within the message to be modified;
generate the comparison string by adding one letter following the modified phrase to the modified phrase if the modified phrase is located at a head of the message to be modified;
generate the comparison string by adding one letter preceding the modified phrase to the modified phrase if the modified phrase is located at a tail of the message to be modified; and
generate the comparison string by adding one letter preceding the modified phrase and one letter following the modified phrase to the modified phrase if the modified phrase is located at a middle of the message to be modified;

7. The communication device of claim 5, wherein the memory includes further instructions for causing the processor to:
receive the modification message:
read a message previously received from a sender by using sender information included in a header of the modification message;
extracting a comparison string from the modification message; and
searching and modifying a phrase to be modified within the previously received message by using the extracted comparison string.

8. The communication device of claim 7, wherein the memory includes further instructions for causing the processor to display a modification detail of the phrase to be modified on the display.
